(19) United States
(12) Patent Application Publication
(10) Pub. No.: US 2004/0078362 A1
(43) Pub. Date: Apr. 22, 2004

(54) System and method for extracting an index for web contents transcoding in a wireless terminal

(76) Inventors: Bumho Kim, Daejeon (KR); Pyeong Soo Mah, Daejeon (KR); Hee-Sook Shin, Daejeon (KR)

Correspondence Address: JACOBSON HOLMAN PLLC, 400 SEVENTH STREET N.W., SUITE 600, WASHINGTON, DC, 20004, US

(21) Appl. No.: 10/365,489

(22) Filed: Feb. 13, 2003

(30) Foreign Application Priority Data
Oct. 17, 2002 (KR) 2002-63497

(51) Int. Cl. G06F 7/00

(52) U.S. Cl. 707/3

(57) ABSTRACT

An index extraction system extracts index information from a web page having web contents which are originally fabricated for use in a personal computer and appropriately displays the extracted index information for a user by using a browser built in a wireless terminal. By performing a contents attribute analysis as well as a HTML tag pattern analysis on a real time basis, index information for use in transcoding web documents can be effectively obtained, thereby increasing effectiveness and flexibility of web contents transcoding.

### FIELD OF THE INVENTION

The present invention relates to a system and method for extracting an index to transcode web contents in a wireless terminal; and, more particularly, to an index extraction system and method capable of extracting index information from a web page having web contents which are originally designed for use in a personal computer and appropriately displaying the extracted index information for a user by using a browser built in the wireless terminal.

### Background of the Invention

In recent years, the use of Internet has been widespread all over the world at an astonishingly fast speed and, now, almost all kinds of information can be obtained on the web. The information on the web is created in the form of a web document by using a HTML (HyperText Markup language); interpreted by a web browser; and then provided to a user through the use of a personal computer (PC) monitor. Recent development of technology for integrating a wireless system with Internet allows a user to access Internet by using terminals having various screen sizes such as a mobile phone, a PDA, an Internet TV, a smart phone, a web pad, etc. However, the physical size of display screens of such mobile terminals does not fully support the data amount that most of the existing web pages contain, so that the data amount inputted to the screens of the mobile terminals may be limited and, thus, the functioning of browsers therein may be also restricted.

Accordingly, there has been intensified a demand for a technology capable of automatically transcoding existing web contents, which have originally been created for PCs connected to a wired network, to be fit to terminals having different display sizes, thereby enabling to offer a web service in both wired and wireless networks without involving additional investment costs.

However, there exists a limitation in transcoding the web contents since HTML tags just describe a visual expression of information but do not specify the meaning of the information, unlike XML tags. Therefore, the web contents transcoding process should be preceded by a process for analyzing the contents to extract meaningful information. At this time, the most meaningful and useful information is information about the structure of web documents. In general, a usual web document has a regular structure. Thus, if the structure of the web document is understood, an efficient web document transcoding can be conducted.

Among various structures of the web document, an index structure such as a menu, a notice board and a table is most important and easy to analyze. The menu supports a random access to contents and, thus, serves as an important element of a remote navigation. The notice board is a structure that a user mainly uses at a web site such as a community site and a data download site, and so forth. The table is a structure for hierarchically organizing important data in the web document. All of these index structures are produced by arranging contents in a regular format. Thus, based on the common characteristics of the index structures, it is possible to extract index information from the web contents, thereby allowing a browser in a wireless terminal to optimize a web page format to successfully display the contents.

Conventionally, a HTML tag pattern analysis is employed to investigate the structure of the web document. However, since focused on tags rather than contents attributes, the conventional HTML tag pattern analysis is lack of preciseness in terms of index extraction. Another method employed in the prior art to extract useful information of the web document is to analyze both the HTML tag patterns and contents relevant to the to-be-extracted information. However, there still exists a necessity to analyze the attributes of the contents in order to fully grasp the structure of the web document.

### Summary of the Invention

It is, therefore, an object of the present invention to provide a system and method for extracting index information required for web contents transcoding in a wireless terminal by analyzing HTML tag patterns and contents attributes on a real time basis.

In accordance with one aspect of the present invention, there is provided a method for extracting an index in an index extraction system for web contents transcoding in a wireless terminal connected to a web server having web contents, the method including the steps of: (a) generating a HTML tag tree from a HTML document; (b) extracting a separation tag from the HTML tag tree; (c) extracting a sub tag tree containing contents from the separation tag; (d) analyzing a HTML tag pattern in the sub tag tree; (e) analyzing a contents attribute in the sub tag tree; and (f) extracting index contents information from the analysis result.

In accordance with another aspect of the present invention, there is provided a system for extracting an index for web contents transcoding in a wireless terminal connected to a web server having web contents, the system including: a HTML tag tree generator for generating a HTML tag tree by receiving a HTML document provided from the web server; a separation tag extractor for extracting a separation tag from the HTML tag tree; a sub tag tree extractor for extracting a sub tag tree having contents from the separation tag; a HTML tag pattern and contents attribute analyzer for analyzing a HTML tag pattern and a contents attribute from the sub tag tree; and an index information extractor for obtaining index contents information from the analysis result provided from the HTML tag pattern and contents attribute analyzer.

### BRIEF DESCRIPTION OF THE DRAWINGS

The above and other objects and features of the present invention will become apparent from the following description of preferred embodiments given in conjunction with the accompanying drawings, in which:

FIG. 1 is a block diagram of an index extraction system for web contents transcoding in a wireless terminal in accordance with the present invention;

FIG. 2 provides a block diagram of an index extractor shown in FIG. 1 in accordance with a preferred embodiment of the present invention;

FIG. 3 illustrates a HTML tag tree generated by a HTML tag tree generator shown in FIG. 2 after the HTML tag tree generator has read a HTML document;

FIG. 4 describes operations of a separation tag extractor shown in FIG. 2 for analyzing the HTML tag tree provided from the HTML tag tree generator and extracting a separation tag;

FIG. 5 exemplifies the separation tag extracted by the separation tag extractor shown in FIG. 2;

FIG. 6 illustrates sub trees containing contents extracted by a sub tag tree extractor shown in FIG. 2 based on the separation tag extracted by the separation tag extractor before the contents are extracted;

FIGS. 7A and 7B depict flowcharts of operations of a HTML tag pattern analyzer shown in FIG. 2;

FIG. 8 explains operations of a contents attribute analyzer shown in FIG. 2 for analyzing various attributes of the contents contained in the sub tag tree and calculating a contents analysis score; and

FIG. 9 shows an example of index information extracted by an index information extractor shown in FIG. 2.

### DETAILED DESCRIPTION OF PREFERRED EMBODIMENTS

First, provided in the following table is a classification of indexes to be extracted in accordance with the present invention.

TABLE 1

| | | | | |
|---|---|---|---|---|
| | | Standard | | |
| | | Deviation of | | Contents |
| Characteristics | Contents | Contents | Contents | Attribute |
| Type | Length | Length | Attributes | Tags |

| | | | | |
|---|---|---|---|---|
| Menu | Short | Small | Text, | Fixed |
| type Index | | | Image, | |
| | | | etc. | |
| Notice Board | Comparatively | Large | Text | Variable |
| type Index | Long and | | | |
| | Variable | | | |
| Table type | Medium | Medium | Text, | Fixed |
| Index | | | Image, | |
| | | | etc. | |

First, the menu type index is for navigation in a web document. The menu type index has a short length and a small standard deviation of text lengths. The index contents may be composed of a text, an image, or other objects and attributes of the index contents are identical.

The notice board type index which is found in a notice board of the web document has a long contents length and a large standard deviation of contents lengths. The contents are mainly composed of texts and the contents attributes may be differed.

The table type index is found in a table of the web document. The table type index has a contents length which is longer than that of the menu type index but shorter than that of the notice board type index. The standard deviation of contents lengths also ranks between the menu type index and the notice type index. The contents of this type index may be composed of a text, an image, or other objects and the index contents attributes are identical.

The index structures, such as a menu, a notice board or a table, are created by arranging contents in a regular format. Therefore, index information can be extracted from the web contents based on this common characteristic of the index structures.

Preferred embodiments of the present invention will now be described hereinafter with reference to the accompanying drawings.

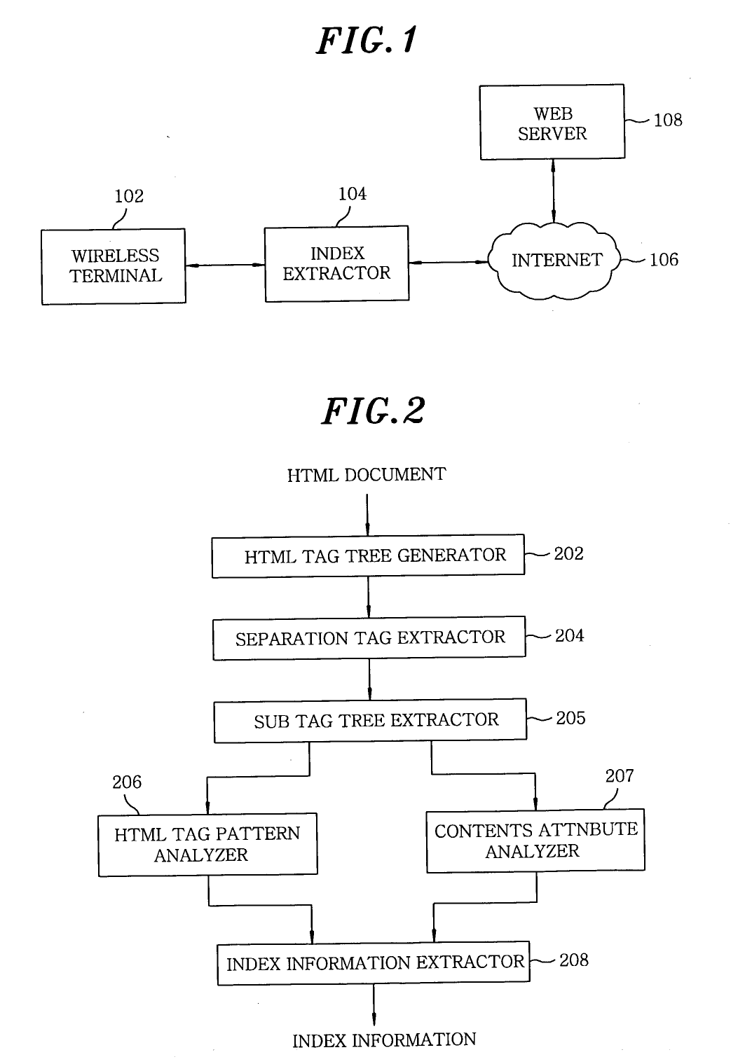

Referring to FIG. 1, there is provided a block diagram of an index extraction system for web contents transcoding in a wireless terminal in accordance with a first embodiment of the present invention. The index extraction system includes a wireless terminal 102, an index extractor 104, Internet 106 and a web server 108.

The wireless terminal 102 is connected to a wireless network via the web server 108 on the Internet 106 and the index extractor 104. If a user requests the web server 108 to provide a HTML document by using a web browser built in the wireless terminal 102, the web server 108 transfers the requested web document to the index extractor 104 through the Internet 106. The index extractor 104 extracts index information from the received HTML document and sends the index information and the HTML document to the wireless terminal 102. The web browser of the wireless terminal 102 receives from the index extractor 104 the HTML document and the index information and displays the received HTML document to be adequate for the display function thereof.

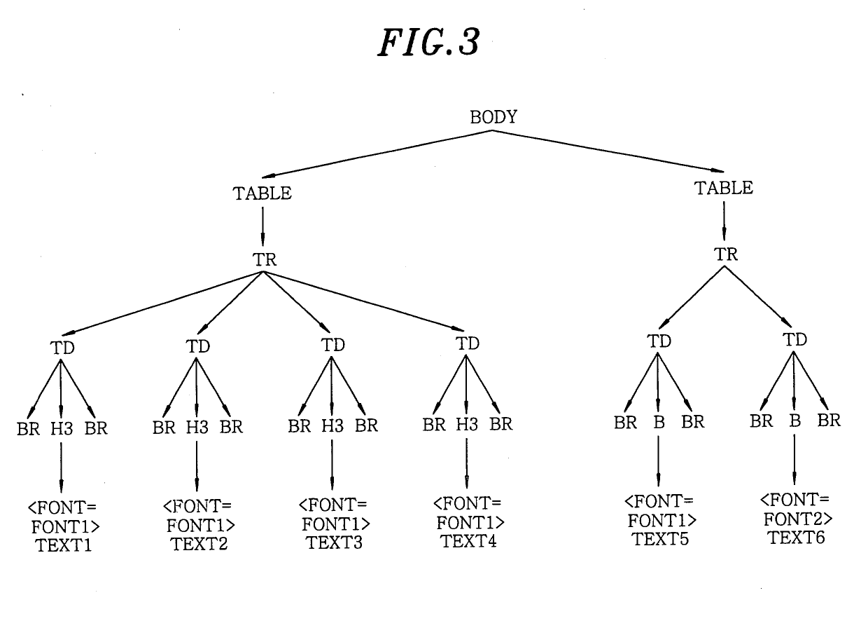

FIG. 2 sets forth a block diagram of the index extractor 104 in accordance with the first embodiment of the present invention. The index extractor 104 includes a HTML tag tree generator 202, a separation tag extractor 204, a sub tag tree extractor 205, a HTML tag pattern analyzer 206, a contents attribute analyzer 207 and an index information extractor 208.

The HTLM tag tree generator 202 receives the HTML document from the web server 108 via the Internet 106 and generates a HTML tag tree. The generated HTML tag tree is provided to the separation tag extractor 204.

The separation tag extractor 204 extracts a separation tag from the HTML tag tree provided from the HTML tag tree generator 202 and offers the separation tag to the sub tag tree extractor 205.

The sub tag tree extractor 205 extracts a sub tag tree containing contents from the separation tag offered from the separation tag extractor 204 and transfers the sub tag tree to the HTML tag pattern analyzer 206 and the contents attribute analyzer 207.

The HTML tag pattern analyzer 206 analyzes a HTML tag pattern by receiving the sub tag tree provided from the sub tag tree extractor 205. Specifically, the HTML tag pattern analyzer 206 examines an occurrence of repetition of a tag pattern and a tag attribute. The analysis result is sent to the index information extractor 208.

The contents attribute analyzer 207 receives the sub tag tree sent from the sub tag tree extractor 205 and analyzes various attributes of the contents contained in the sub tag tree. The analysis result is provided to the index information extractor 208.

The index information extractor 208 extracts index information based on the analysis results provided from the HTML tag pattern analyzer 206 and the contents attribute analyzer 207.

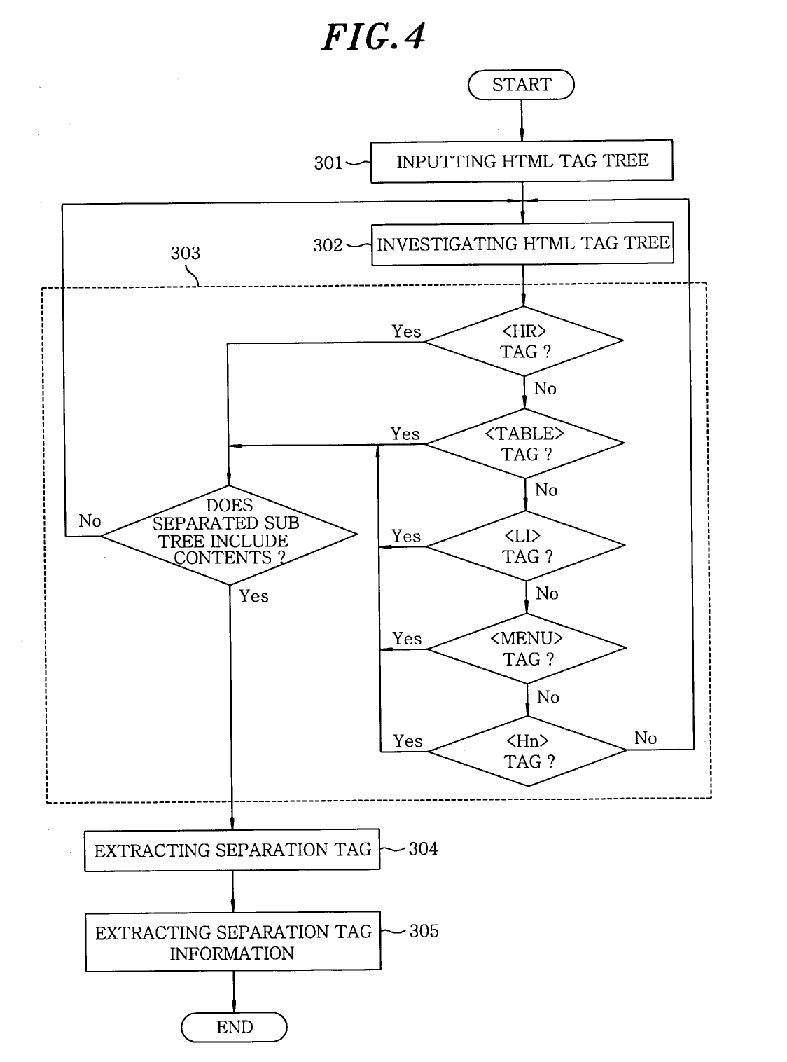

Referring to FIG. 3, there is illustrated a tag tree created by the HTML tag tree generator 202. Herein, the HTML document is recomposed into a tag tree structure for the reason of the analytical easiness of the tag structure. Contents contained in the HTML document is also considered as a tag element and, thus, included in the tag tree structure. The references text1, text2, text3, text4, text5 and text6 shown in FIG. 3 represent not the HTML tags but the contents contained in the HTML document. The contents are included in the tag tree structure because an index is extracted based on contents attributes as well as a tag analysis result.

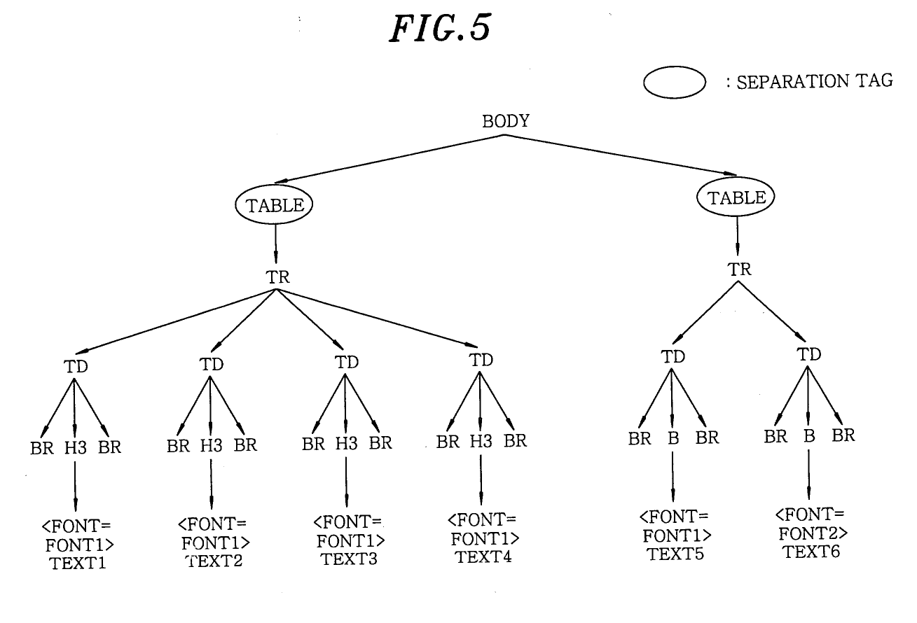

FIG. 4 depicts a flowchart of the HTML tag tree analysis process and the separation tag extraction process performed by the separation tag extractor 204.

The separation tag extractor 204 receives the HTML tag tree from the HTML tag tree generator 202 (Step 301).

Then, the separation tag extractor 204 examines the inputted HTML tag tree by employing a depth first search (DFS) method (Step 302).

If the separation tag is found in the examination process in the step 302, the separation tag extractor 204 determines whether the separated sub tree contains contents (Step 303).

If the separated sub tree includes contents, the separation tag extractor 204 extracts the separation tag (Step 304).

Thereafter, the separation tag extractor 204 extracts the separation tag information (Step 305).

The separation tag herein used refers to a tag used to separate sub trees for the purpose of analyzing the HTML document. In general, a web document produced by a web design tool has a regular format. A web document created by using a HTML tag, not a web design tool, also has a regular alignment and design format adopted by a web document designer. The index structures are produced by using the tags which serve to classify indexes. Thus, by considering the incidence and the pattern of the separation tags, the preciseness of index information extraction process can be increased. The following are separation tags.

| Separation tag = { | |
|---|---|
| <HR> | horizontal rule |
| <Table> | table |
| <LI> | list item |
| <MENU> | menu list |
| <Hn> | header |
| } | |

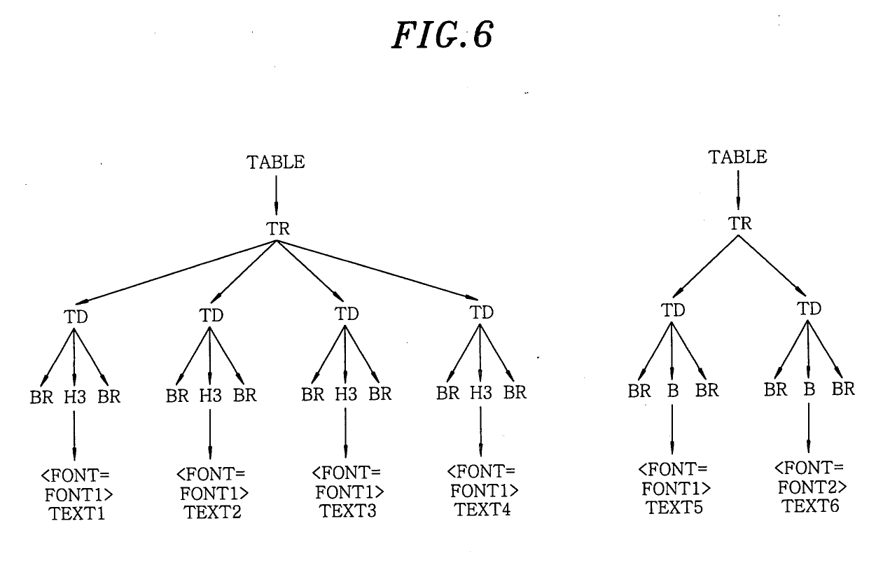

Referring to FIG. 5, there is exemplified the separation tags extracted by the separation tag extractor shown in FIG. 2. The <Table> tag in FIG. 2 is the extracted separation tag containing contents, which is extracted by examining the HTML tag tree through the use of DFS method.

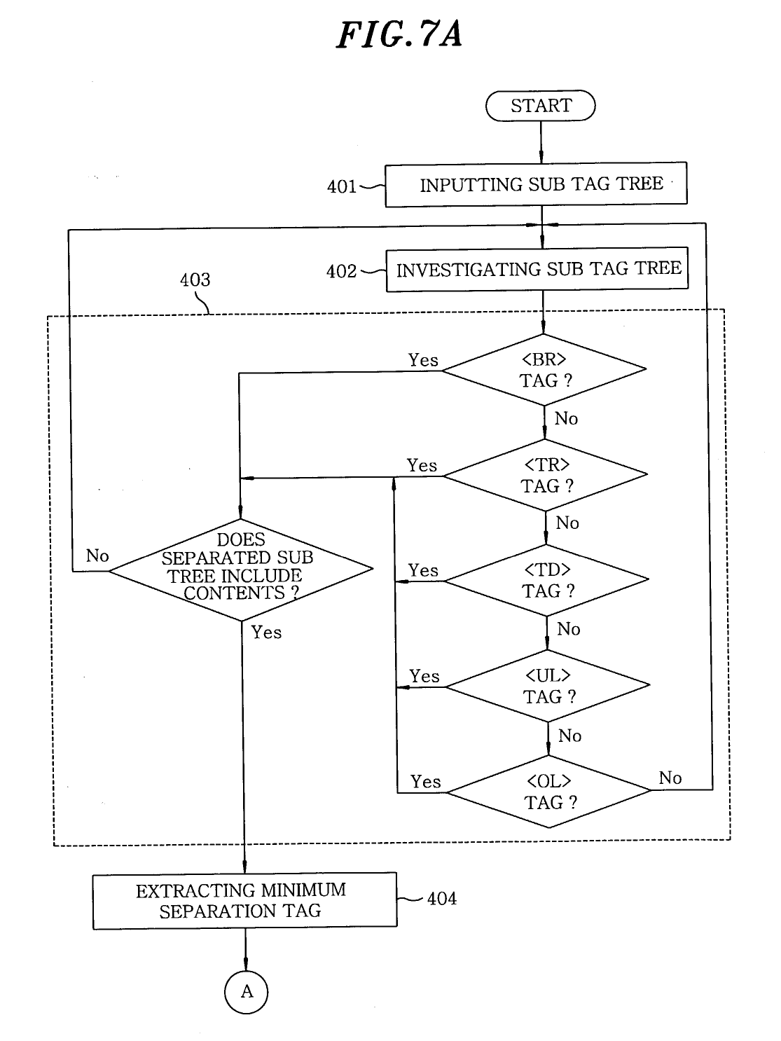

FIG. 6 illustrates the sub trees containing contents extracted by the sub tag tree extractor 205 before extracting the contents based on the separation tag obtained by the separation tag extractor 204. The sub tag tree extractor 205 extracts the sub trees containing contents from the whole tree structure based on the separation tags obtained by the separation tag extractor 204.

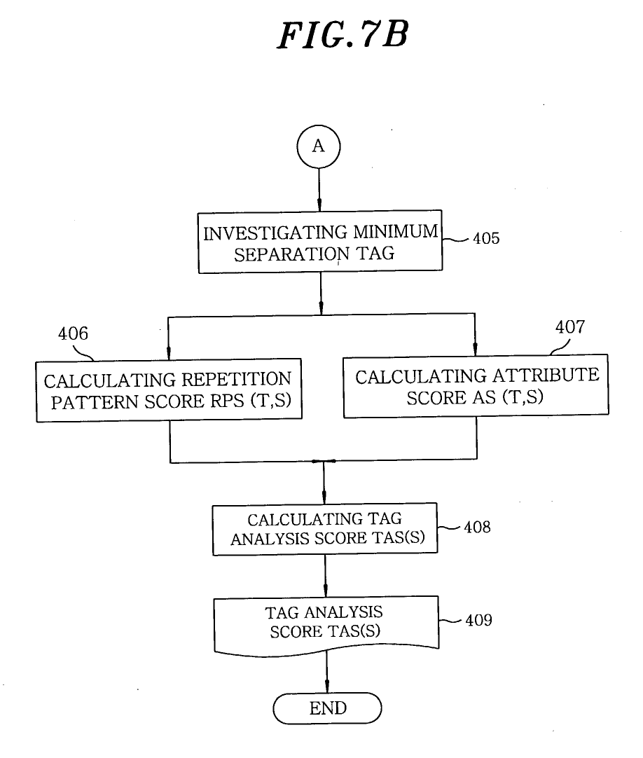

FIGS. 7A and 7B describe operations of the HTML tag pattern analyzer 206 shown in FIG. 2. In the sub trees obtained by the sub tag tree extractor 205, there may exist pairs of tags and tag attributes that appear repeatedly. The degree of repetition of the tag patterns and the tag attributes can be calculated as follows.

First, the sub tag trees are inputted from the sub tag tree extractor 205 to the HTML tag pattern analyzer 206 (Step 401).

Then, the HTML tag pattern analyzer 206 investigates the inputted sub tag trees by employing a DFS method (Step 402).

If a minimum separation tag is found, the HTML tag pattern analyzer 206 determines whether the separated sub tree includes contents (Step 403).

If the separated sub tree includes contents, the HTML tag pattern analyzer 206 extracts the minimum separation tag (Step 404).

Then, the HTML tag pattern analyzer 206 examines the minimum separation tag tree (Step 405).

Thereafter, the HTML tag pattern analyzer 206 investigates the minimum separation tags to estimate a repetition pattern score (RPS) (Step 406) and an attribute score (AS) (Step 407).

The HTML tag pattern analyzer 206 calculates and outputs a tag analysis score (TAS) (Steps 408 and 409).

Herein, the sub trees are divided in a unit of minimum separation tag tree. The minimum separation tag refers to the tag which serves to divide the sub trees into trees individually containing a single content for the purpose of analyzing the tags on a content basis. In other words, the minimum separation tag serves to identify a start point and an end point of respective contents.

| Minimum separation tag = { | |
|---|---|
| <BR> | line break |
| <TR> | row in a table |
| <TD> | cell in a table |
| <UL> | unordered list |
| <OL> | ordered list |
| } | |

By analyzing the sub trees based on the separation tags described above, the minimum separation tag trees respectively containing a single content can be obtained. Then, by investigating the separated minimum separation tag trees, the consistency and the attributes of the tags that appear repeatedly are examined to obtain a tag analysis score. The equation 1 is used to calculate a tag analysis score of a sub tree S.

$$TAS ( S ) = α \cdot RPS ( T , S ) + ( 1 - α ) \cdot AS ( T , S ) \\ ( S = {\sum }_{i = 1}^{n} {S}_{i} ) \qquad Eq . 1$$

Herein, RPS(T,S) and AS(T,S) respectively represent a repetition pattern score and an attribute score. α refers to a parameter which is used to adjust the weight of the RPS and the AS. Equations for obtaining a RPS of a the sub tree S are provided as follows.

$$RPS ( T , S ) = {\prod }_{i = 1}^{n} \frac{RP ( T , {S}_{i} )}{RP ( T , {S}_{1} )} \qquad Eq . 2$$

RPS(T,S) represents a degree of repetition of the pairs of tags that appear repeatedly in the tag tree and RP(T,S) stands for a list of the tags that appear repeatedly. The rate of RP(T,Sᵢ) to RP(T,S₁) is a conformity rate of a tag pattern of a ith minimum separation tag tree Sᵢ to a tag pattern of a first minimum separation tag tree S₁.

The attribute score AS(T,S) of the sub tree S valuates the consistency of the attributes of, e.g., an attribute tag for characters or a tag for giving effect on words or phrases. These tags cannot be analyzed by a repetition pattern since the attributes of these tags are maintained until the next attribute tag appears.

In case of the notice board type index, the weight of the attribute score may need to be lowered by adjusting the parameter α, since the notice board type index has a variety of tag attributes.

Attribute tags can be classified into character attribute tags for defining the size, font, color and alignment of characters, logical style tags for specifying the logical style of contents, and physical attribute tags for designating a physical attribute of contents in the web browser. The character attribute tags, the logical style tags and the physical attribute tags are exemplified as follows.

| | |
|---|---|
| Character attribute tag = { | |
| <font size = “1˜7”> | size of a character |
| <font face = “font name”> | font of a character |
| <font color = “RGB color value”> | color of a character |
| <div align = “left \| center \| right”> | |

alignment of a character

}

| Logical attribute tag = { | |
|---|---|
| <EM> | emphasis |
| <Strong> | strong emphasis |
| <DFN> | definition of word |
| <VAR> | variable name |
| <CODE> | program source code |
| <CITE> | citation |
| <KBD> | text typed by a user on the key board |
| <SAMP> | character string |
| Physical attribute tag = { | |
| <B> | bold |
| <I> | italic |
| <TT> | teletype |
| <U> | underline |
| <S> | struct through horizontal line |
| <Strike> | struct through horizontal line |
| <Big> | big |
| <Small> | small |
| <SUB> | subscript |
| <SUP> | superscript |

}

The attribute score AS (T,S) of the sub tree S can be obtained by using Equation 3 provided as follows:

$$AS ( T , S ) = {\prod }_{i = 1}^{n} \frac{A ( T , {S}_{i} )}{A ( T , {S}_{1} )} \qquad Eq . 3$$

wherein AS(T,S) is obtained by comparing the attribute tags in the sub tag tree S and converting the comparison result into a value. A(T,Sᵢ) represents a tag attribute list of an ith minimum separation tag tree and the rate of A(T,Sᵢ) to A(T,S₁) refers to a conformity rate of the tag attribute of an ith minimum separation tag tree Sᵢ to the tag attribute of a first minimum separation tag tree S₁.

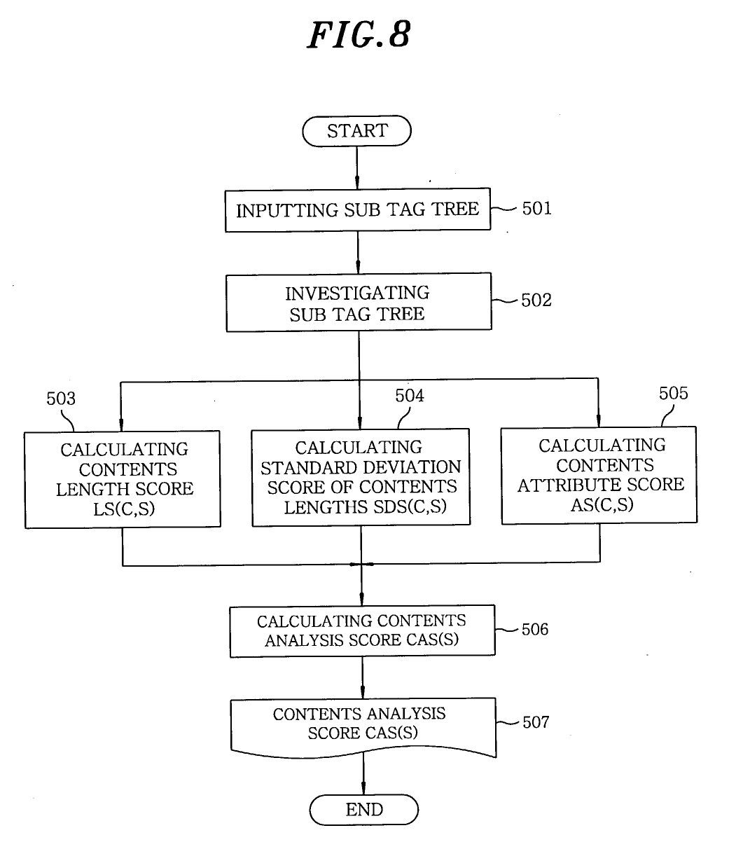

Referring to FIG. 8, there is provided a flowchart of operations of the contents attribute analyzer 207, shown in FIG. 2, which analyzes various attributes of the contents contained in the sub tag tree to calculate a content analysis score (CAS).

First, the contents attribute analyzer 207 receives the sub tag tree provided from the sub tag tree extractor 205 (Step 501).

Then, the contents attribute analyzer 207 examines the inputted sub tag tree (Step 502).

Thereafter, the contents attribute analyzer 207 compares the lengths of extracted contents lists and determines the contents of a similar length as an index (Step 503). The determination is based on the fact that index contents of a menu type index have comparatively uniform lengths. Then, the contents attribute analyzer 207 compares standard deviations of contents list lengths in order to increase preciseness of the index extraction based on the comparison of the contents lengths (Step 504). Afterwards, the contents attribute analyzer 207 compares the attributes of the contents, thereby increasing the preciseness of extracting an index composed of texts and, further, an index composed of other objects (Step 505).

After performing the steps 503 to 505, the contents attribute analyzer 207 calculates the CAS by employing Equation 4 as follows (Steps 506 and 507).

CAS(S)=α·LS(C,S)+β·SDS(C,S)+γ·AS(C,S) Eq. 4

(α+β+λ=1)

Herein, LS(C,S) refers to a contents length score while SDS(C,S) and AS(C,S) respectively represent a contents length standard deviation score and a contents attribute score. The three parameters α, β, λ are employed to adjust the weight of the contents length score, the contents length standard deviation score and the contents attribute score, respectively.

α is a parameter for use in determining whether or not to-be-extracted index information is of a notice board type. If α is large, it implies the to-be-extracted index information is likely to be a notice board type index while if α has a small value, it means that the to-be-extracted index information is closer to a menu type index. β is a parameter for determining the weight of the standard deviation score of the contents lengths. If β has a large value, the to-be-extracted index is closer to the notice board type index while if β has a small value, the to-be-extracted index is likely to be the menu type index. λ is a parameter for use in determining whether the to-be-extracted index contents are texts, images or something else other than the texts and the images. For example, if λ=1, i.e., α+β=0, it means that the index is made of, e.g., images, not texts. In such case, the CAS can be obtained from the AS(C,S) since the LS(C,S) and the SDS(C,S) cannot be calculated.

The LS(C,S) representing the contents length score of the sub trees is an average value of text contents lengths of minimum separation tag trees in the sub tree S. The LS(C,S) can be obtained as follows.

$$LS ( C , S ) = \frac{{\sum }_{i = 1}^{n} L ( C , {S}_{i} )}{N} \qquad Eq . 5$$

Herein, the SDS(C,S) stands for a standard deviation of the text contents lengths of the minimum separation tag trees in the sub tree S. The SDS(C,S) can be calculated as follows.

$$SDS ( C , S ) = \sqrt{\frac{{\sum }_{i = 1}^{n} {( LS ( C , S ) - L ( C , {S}_{i} ) )}^{2}}{N}} \qquad Eq . 6$$

The contents attribute score AS(C,S) is obtained as follows:

$$AS ( C , S ) = {\prod }_{i = 1}^{n} \frac{A ( C , {S}_{i} )}{A ( C , {S}_{1} )} \qquad Eq . 7$$

wherein the A(C,Sᵢ) is calculated by comparing the attributes of the contents in the sub tag tree S and converting the comparison result into a value. The A(C,S₁) is a contents attribute list of a first minimum separation tag tree and the A(C,Sᵢ)/A(C,S₁) refers to a conformity rate of the contents attribute of an ith minimum separation tag tree Sᵢ to the contents attribute of a first minimum separation tag tree S₁.

The index information extractor 208 extracts an index by combining values obtained by the HTML tag pattern analyzer 206 and the contents attribute analyzer 207. To be more specific, the index information extractor 208 calculates an index score (IS) of each sub tag tree S by using the TAS and the CAS values respectively obtained by the HTML tag pattern analyzer 206 and the contents attribute analyzer 207. Then, the index information extractor 208 finally obtains index information by using Equation 8 as follows.

IS(S)=α·TAS(S)+(1−α)·CAS(S) Eq. 8

Herein, α is a parameter for adjusting the weight of the TAS and the CAS. The weight of the TAS is increased if α is large, while the weight of the CAS is increased if α is small. Therefore, the former case is applied to extracting the notice board type index contents while the latter is applied to extracting the menu type index contents.

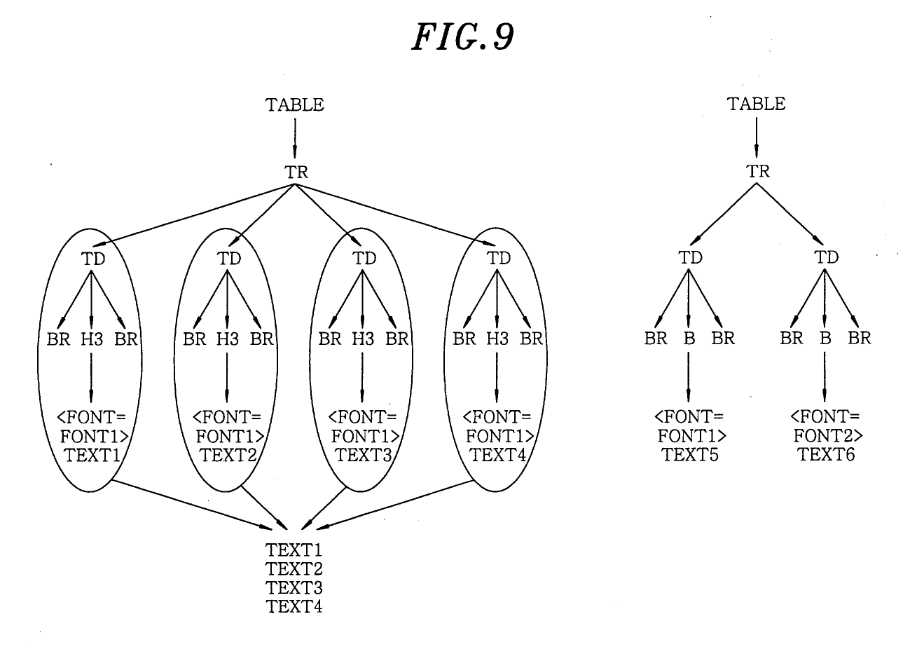

FIG. 9 exemplifies index information {text1, text2, text3, text4} obtained by the index information extractor 208 shown in FIG. 2.

While the invention has been shown and described with respect to the preferred embodiments, it will be understood by those skilled in the art that various changes and modifications may be made without departing from the spirit and scope of the invention as defined in the following claims.

What is claimed is:

1. A method for extracting an index in an index extraction system for web contents transcoding in a wireless terminal connected to a web server having web contents, the method comprising the steps of:
(a) generating a HTML tag tree from a HTML document;
(b) extracting a separation tag from the HTML tag tree;
(c) extracting a sub tag tree containing contents from the separation tag;
(d) analyzing a HTML tag pattern in the sub tag tree;
(e) analyzing a contents attribute in the sub tag tree; and
(f) extracting index contents information from the analysis result.

2. The method of claim 1, wherein the step (b) includes the steps of:
(b1) investigating the HTML tag tree by using a DFS (depth first search) method;
(b2) determining whether a separated sub tree includes contents if the separation tag is found in the investigation process; and
(b3) extracting the separation tag if the separated sub tree includes contents.

3. The method of claim 1, wherein the step (d) includes the steps of:
(d1) investigating the sub tag tree by using a DFS method;
(d2) determining whether a separated sub tree includes contents if a minimum separation tag is found in the investigation process;
(d3) extracting the minimum separation tag if the separated sub tree includes contents;
(d4) inspecting the extracted minimum separation tag;
(d5) examining consistency of tags that appear repeatedly to calculate a repetition pattern score and an attribute score; and
(d6) calculating a tag analysis score.

4. The method of claim 1, wherein the step (e) includes the steps of:
(e1) investigating the sub tag tree;
(e2) comparing lengths of extracted contents lists and deciding the contents of a similar length as an index;
(e3) calculating a standard deviation of the lengths of the contents lists in order to increase preciseness of index extraction;
(e4) comparing contents attributes in order to increase preciseness of extracting contents composed of a text or other objects; and
(e5) calculating a contents analysis score (CAS) by using an equation as follows:
CAS(S)=α·LS(C,S)+β·SDS(C,S)+γ·AS(C,S)
(α+β+γ=1)
wherein LS(C,S), SDS(C,S) and AS(C,S) respectively refer to a contents length score, a contents length standard deviation score and a contents attribute score.

5. A system for extracting an index for web contents transcoding in a wireless terminal connected to a web server having web contents, the system comprising:
a HTML tag tree generator for generating a HTML tag tree by receiving a HTML document provided from the web server;
a separation tag extractor for extracting a separation tag from the HTML tag tree;
a sub tag tree extractor for extracting a sub tag tree having contents from the separation tag;
a HTML tag pattern and contents attribute analyzer for analyzing a HTML tag pattern and a contents attribute from the sub tag tree; and
an index information extractor for obtaining index contents information from the analysis result provided from the HTML tag pattern and contents attribute analyzer.

6. The system of claim 5, wherein the separation tag extractor investigates the HTML tag tree by employing a DFS method and extracts the separation tag if the separation tag is found in the investigation process and a separated tag tree includes contents.
